(19) United States
(12) Patent Application Publication
(10) Pub. No.: US 2026/0022748 A1
(43) Pub. Date: Jan. 22, 2026

(54) Braking System and Braking System Provision Method

(71) Applicant: KNORR-BREMSE Systeme fuer Nutzfahrzeuge GmbH, Muenchen (DE)

(72) Inventors: Philipp ADAMCZYK, Bernried (DE); Michael BLESSING, Muenchen (DE); Zsombor GYOERKE, Keszthely (HU); Korbinian HEIGL, Muenchen (DE); Levente HOES, Budapest (HU); Mate HOLLOSI, Budapest (HU); Matthias KLINGNER, Adelshofen (DE); Csaba KOKREHEL, Budapest (HU); Sven KRUEGER, Muenchen (DE); Gyula MONORI, Lakitelek (HU); Tatsuro NAKAMURA, Budapest (HU); Michael PESCHEL, Schoengeising (DE); Janos TOTH, Kecskemet (HU); Tamas TOTH-KATONA, Budapest (HU); Tobias SCHOEFBERGER, Mainburg (DE); Janos SZABO, Budapest (HU)

(21) Appl. No.: 18/996,028

(22) PCT Filed: Jul. 7, 2023
(86) PCT No.: PCT/EP2023/068834

§ 371 Date: Jan. 17, 2025

(30) Foreign Application Priority Data
Jul. 19, 2022 (EP) 22185875.6

(51) Int. Cl. F16D 65/18; B60T 1/06; B60T 11/10; F16D 55/2255

(52) U.S. Cl. CPC F16D 65/18; B60T 1/065; B60T 11/102; F16D 55/2255; B60T 2270/402; F16D 2250/0084

(57) ABSTRACT

A braking system and method of providing a braking system includes: a rotatory braking element that is fixedly connected to a wheel or wheel hub in a manner to rotate conjointly with the wheel, a stationary braking element that is fixedly connected to a vehicle chassis, a brake actuator that is configured to actuate the stationary braking element so as to press the stationary braking element towards the rotatory element, a lever that is configured so as to transfer a force exerted by the brake actuator to the stationary brake element, wherein a pivot axis of the lever is in parallel with a rotational plane of the rotatory braking element and perpendicular to a horizontal caliper plane that is a plane that is oriented tangentially of the rotatory brake element, and an actuator axis is in parallel with the rotational plane and the horizontal caliper plane.

### BACKGROUND AND SUMMARY

The invention relates to a braking system and braking system provision method and, in particular, relates to a braking system and braking system provision method for braking systems of road vehicles.

Commercial vehicles, like trucks, tractor units or trailers, comprise braking systems capable of applying braking forces to axles or wheels to decelerate the commercial vehicles during a driving operation or to secure the commercial vehicles against an unintended movement during non-driving operations. Such braking systems usually consist of a main braking system/service braking system and an auxiliary braking system/parking braking system. Usually, the main braking system/service braking system is intended to be used during operation of the vehicle and the auxiliary braking system serves as a backup braking system for the main braking system or provides a continuous locking function to maintain vehicle's position in particular when the vehicle is not operated.

Such braking systems and respective brake actuators are arranged near the axle or wheel to be decelerated or secured. However, the installation space near the axle or wheel is limited.

In the related art, braking systems are known that are disc brakes, in particular air disc brakes especially for commercial vehicles, i.e. the deceleration force is generated such that a rotatory braking element like a brake disc is fixed to a wheel or an hub to be braked in a manner that the rotatory braking element rotates conjointly with the wheel or hub. A stationary braking element that is stationary with respect and in contrast to the rotation of the rotatory braking element like a caliper with braking pads is mounted to a vehicle such that it basically remains stationary with respect to the chassis of the vehicle. In such known related art braking systems, the braking pads and the caliper generate a clamping force that acts on the brake disc such that relative movement, in particular relative rotation between the brake disc and the braking pads are slowed down by friction between the brake disc and the braking pads. The force acting on the braking pads is generated via an eccentric lever and an actuator, e.g. an pneumatic actuator. In FIG. 1 and FIG. 2, such related art braking systems are shown. As it can be seen in FIG. 1, a pivotal axis 1 of an eccentric lever 2 extends in parallel to a horizontal caliper plane 3 that is a plane that extends tangentially to a brake disk 9 at the site of a caliper 4. The brake system further comprises an actuator 5 consisting of a service brake portion 6 and a parking brake portion 7 that are arranged in series in a common housing and that act along an actuator axis 8. The exact orientation of the pivotal axis 1 may vary by about 15°.

In an axial brake configuration as shown in FIG. 1, the actuator axis 8 is oriented in parallel to the horizontal caliper plane 3 and perpendicular with a disc center plane 10 that is a plane that extends in parallel to an extension of the brake disc 9, i.e. perpendicular to the rotational axis of the braking disc 9 and is located at the center of the braking disc 9. The exact orientation of the actuator axis 8 may vary by about 15°. In a radial brake configuration as shown in FIG. 2, an actuator 5′ may be oriented such that its actuator axis 8′ is oriented perpendicular to the horizontal caliper plane 3 and in parallel with a disc center plane 10. The exact orientation of the actuator axis 8 may vary by about 15°. In both cases, a bridge guidance 12 of a bridge 11 is generally oriented perpendicular to the disc center plane 10.

The related art exhibit the problem that, due to the current arrangement, the braking system including the actuator consumes a significant axial installation space, i.e. a large space along the wheel axis, perpendicular to the disc center plane 10, in case of an axial brake. In case of a radial brake, a significant installation space in a radial direction is required. E.g., a “radial” brake cannot be mounted in 6 o'clock position with the actuator facing downwards, because the parking brake portion could collide with the road surface. Furthermore, it is not possible to separate the service brake portion 6 and parking brake portion 7 and arrange one portion on left and one portion on the right side of eccentric lever 2. This leads to a collision with the wheel rim in case of axial brake of FIG. 1 or to a collision with axle bodies in case of a radial brake. Furthermore, in case of an axial brake, the maximum size of the eccentric lever 2 is limited due to the space between knuckle and rim or axle and rim. Furthermore, in case of a radial brake, the minimum lever size is limited due to the wheel width including tires including snow chains and the actuator diameter.

It is an object of the invention to solve the problems of the related art and to provide a braking system and braking system provision method that allows for providing braking systems requiring less space and having improved space requirements. In particular it is object of the invention to reduce axial and radial installation space especially if a parking brake function is needed and avoid the need of a radial brake which is mostly used on front axles or so-called portal axles in city bus application. Furthermore, the invention provides a solution to arrange the actuators closer to the caliper guidance in order to reduce the dynamic load on the guidance. Furthermore, the invention provides more flexibility to define the lever geometry in order to optimize ratio, progression and hysteresis of the brake mechanism.

The object is solved by the subject-matter of the independent claims. Advantageous further developments are subject-matter of the dependent claims.

Disclosed is a braking system for a vehicle, comprising: a rotatory braking element that is fixedly connected to a wheel or wheel hub in a manner to rotate conjointly with the wheel, a stationary braking element that is fixedly connected to a vehicle chassis, a brake actuator that is configured to actuate the stationary braking element such as to press the stationary braking element towards the rotatory element, a lever that is configured such that it transfers a force exerted by the brake actuator to the stationary brake element, wherein a pivot axis of the lever is in parallel with a rotational plane of the rotatory braking element and perpendicular to a horizontal caliper plane that is a plane that is oriented tangentially of the rotatory brake element and an actuator axis is in parallel with the rotational plane and the horizontal caliper plane.

Advantageously, the brake actuator comprises a main brake actuator and an auxiliary braking actuator that are arranged at different sides of the lever.

Advantageously, a main brake actuator axis and an auxiliary brake actuator axis deviate from a mutual orientation that is parallel to each other.

Advantageously, the main brake actuator axis and the auxiliary brake actuator axis are arranged coaxially with an angle of 5° with respect to the rotational plane.

Advantageously, a transfer element is arranged between the lever and the stationary braking element.

Advantageously, the orientation of the transfer element is inclined with respect to the rotational plane, in particular inclined by 4° with respect to the rotation direction.

Disclosed is a method of providing a braking system comprising the steps of: a) providing a rotatory braking element that is fixedly connected to a wheel or wheel hub in a manner to rotate conjointly with the wheel, b) providing a stationary braking element that is fixedly connected to a vehicle chassis, c) providing a brake actuator that is configured to actuate the stationary braking element such as to press the stationary braking element towards the rotatory element, d) providing a lever that is configured such that it transfers a force exerted by the brake actuator to the stationary brake element, wherein step d) further comprises: da) orienting a pivot axis of the lever in parallel with a rotational plane of the rotatory braking element and perpendicular to a horizontal caliper plane that is a plane that is oriented tangentially of the rotatory brake element, and step c) further comprises ca) orienting an actuator axis in parallel with the rotational plane and the horizontal caliper plane.

Advantageously, step c) comprises: cb) providing a main brake actuator, and cc) providing an auxiliary braking actuator, and cd) arranging the main brake actuator and the auxiliary brake actuator at different sides of the lever.

Advantageously, step cd) further comprises: cda) arranging a main brake actuator axis and an auxiliary brake actuator axis such that they deviate from a mutual orientation that is parallel to each other.

Advantageously, the method further comprises the step: e) providing a transfer element between the lever and the stationary braking element.

In the following, the invention is explained by means of embodiments and the figures.

### BRIEF DESCRIPTION OF THE DRAWINGS

FIG. 1 illustrates a braking system known from the related art.

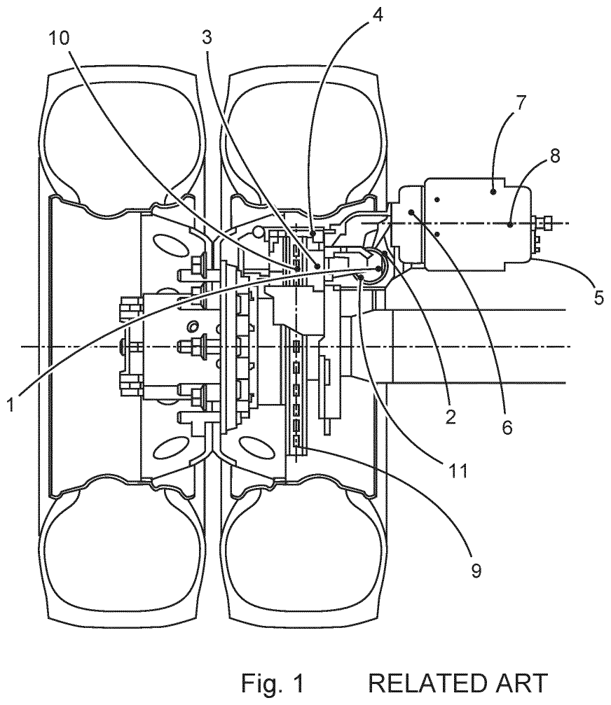

FIG. 2 illustrates a further braking system known from the related art.

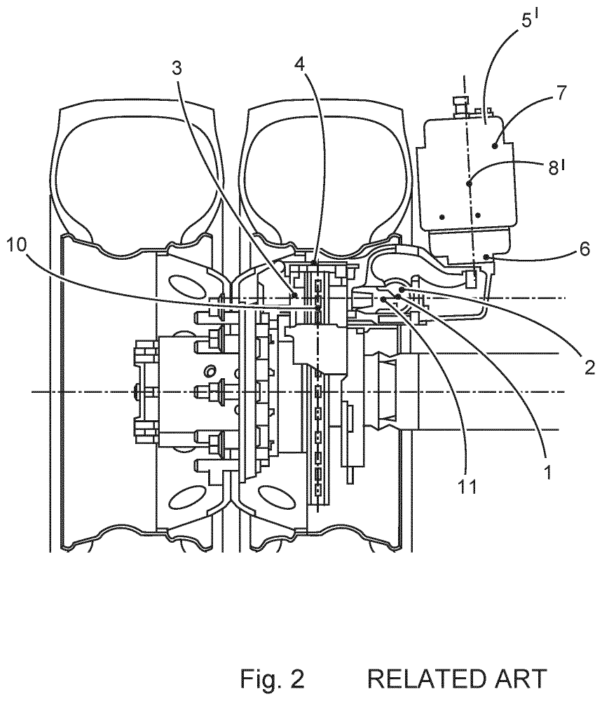

FIG. 3 is a top view of a braking system according to an embodiment of the invention.

FIG. 4 is an axial view/side view of the braking system according the embodiment.

FIG. 5 illustrates a first modification of the braking system according the embodiment.

FIG. 6 illustrates a second modification of the braking system according the embodiment.

### DETAILED DESCRIPTION OF THE DRAWINGS

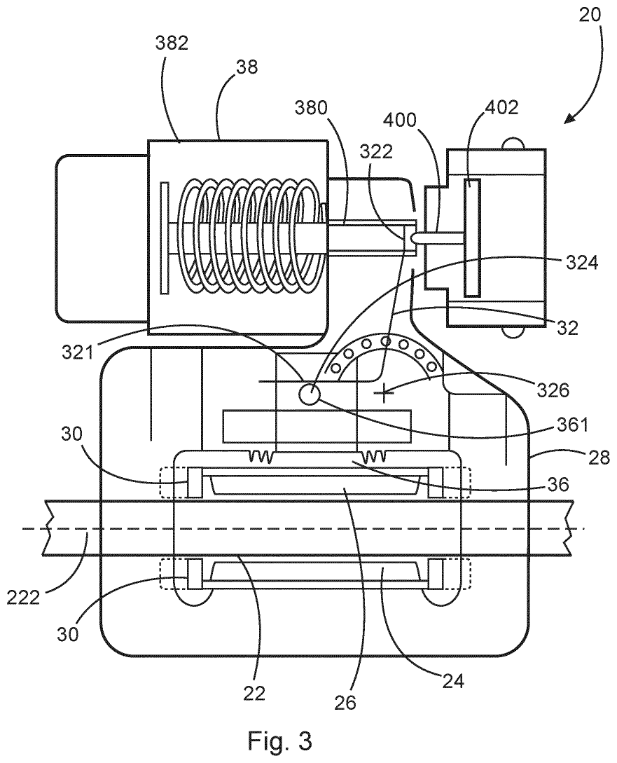

FIG. 3 shows a braking system 20 according to an embodiment of the invention in a top down illustration. The braking system 20 comprises a brake disc 22 as a rotatory braking element having a disc center plane 222, and an outboard brake pad 24, an inboard brake pad 26 and a caliper 28 as stationary braking elements. The outboard brake pad 24 is supported in the caliper 28 by carriers 30 such that the outboard brake pad 24 is rigidly fixed in the caliper. The inboard brake pad 26 is supported in the caliper 28 by the carriers 30 such that it is movable towards and away from the brake disc 22. The caliper 28 and the brake pads 24, 26 are configured such as to form a floating caliper. A lever 32 comprises a shaft that is supported in a needle bearing 235. The center of the shaft and the needle bearing serve as a pivot axis 326 of the lever 32. The lever 32 further comprises a first end portion 321 that is connected to a bridge 35. The lever 32 transfers braking force to a brake slider 36 via the bridge 35. The bridge 35 is configured such as to be adjustable in the angle with which the bridge 35 may transfer force to the brake slider 36. The brake cylinder acts on the inboard braking pad 26. Although the braking system of the embodiment is configured as single piston system, also multi piston systems are applicable. The lever 32 comprises a second end portion 322 that is connected to a parking brake rod 380 on the one side and a service brake rod 400 at the other side.

A parking brake actuator 38 comprises the parking brake rod 380. The parking brake rod is urged inwardly position by a spring arrangement 382 that is located inside the parking brake actuator 38. By that, the parking brake rod 380 and the lever 32 is urged towards a locking position in that braking is applied to the vehicle. In an operative state of the vehicle, the parking brake actuator 38 is kept in an extended configuration by a pneumatic pressure. By that, the parking brake rod 380 is urged towards an extended open position in that no braking is applied via the lever 32.

A service brake actuator 40 contains the service brake rod 400. By a pneumatic cylinder 402, the service brake rod 400 may be urged outwardly. By that, the lever 32 is urged towards a close position.

As it can be seen, the pivotal axis 326 of the lever 32 is oriented perpendicular to a horizontal caliper plane 42 that is a plane that is oriented in a tangential direction of the brake disc 22 at the location of the caliper 28. Deviations of the pivotal axis 326 from that orientation in any direction of up to 15° are possible.

As it can be further seen, the parking brake actuator axis 384 along the parking brake rod 380 and the service brake actuator axis 404 along the service brake rod 400 are arranged parallel to the disc center plane 222 and parallel to the horizontal caliper plane 42. Deviations of the actuator axes 384 and 404 from that orientation in any direction of up to 15° are possible.

Further, as it can be seen in FIG. 3, a service brake portion and a parking brake portion of an actuator may be separated and may be placed on both sides of the second end portion 322 of the lever 32 as the parking brake actuator 38 and the service brake actuator 40.

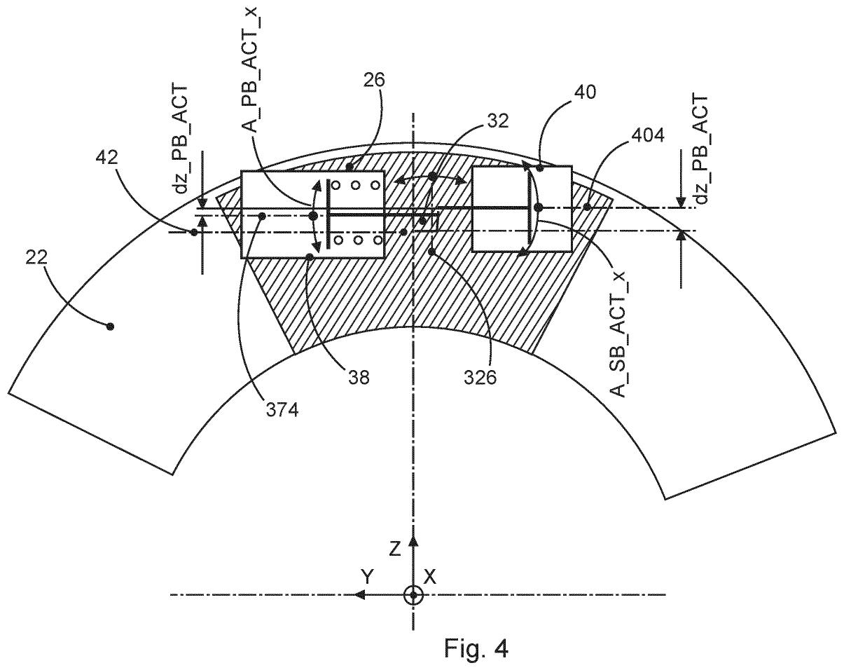

FIG. 4 illustrates the braking system 20 of the embodiment of the invention in a side view.

In the embodiment, the parking brake actuator axis 384 and the service brake actuator axis 404 are parallel to each other.

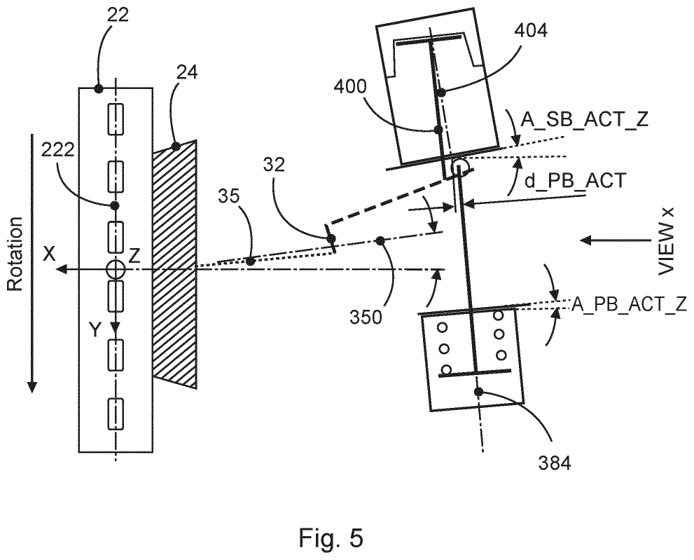

FIG. 5 illustrates a first modification of the embodiment. In the embodiment, the bridge guide plane 350 of the bridge 35 that defines the direction of possible movement of the bridge 35, is oriented perpendicular to the disc center plane 222 in parallel with a wheel hub. However, with the arrangement of the embodiment, it is optionally possible to adjust the inclination of the bridge guide plane 350 to an angle different from perpendicular to the disc center plane 222.

Further the inclinations of the parking brake actuator axis 384 and the service brake actuator axis 404 may be varied with respect to the disc center plane 222 depending e.g. on the size of the parking brake actuator 38 and the service brake actuator 40 or other parts of the vehicle.

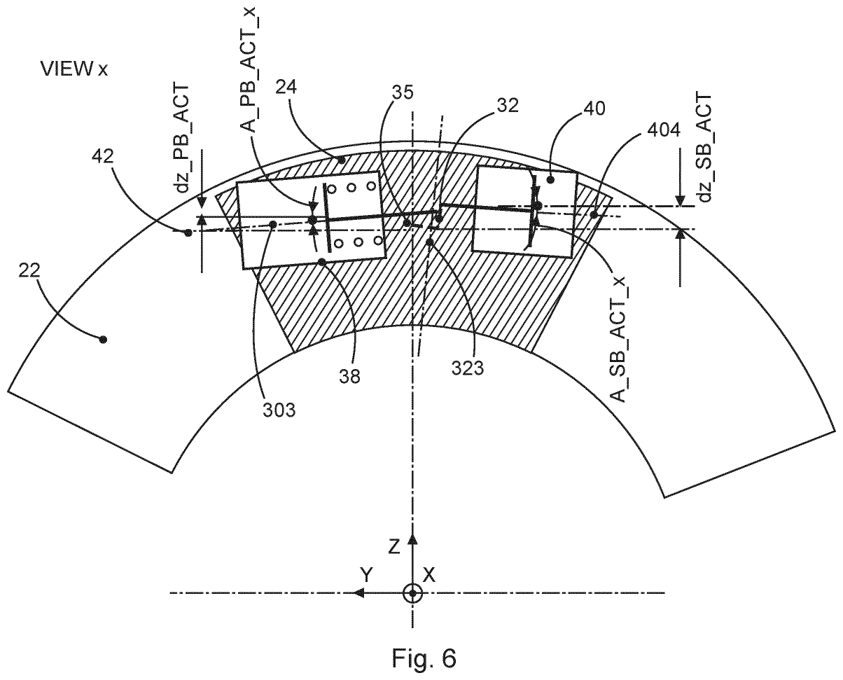

FIG. 6 illustrates a second modification of the embodiment. As it can be seen in conjunction with FIG. 5, the axis of the parking brake actuator 38 and the service brake actuator 40 can have different inclination angles (A_SB_ACT_x and A_PB_ACT_x and A_SB_ACT_z and A_PB_ACT_z) or an offset between the parking brake actuator 38 and the service brake actuator 40 (dx_PB_ACT and dz_PB_ACT). The service brake actuator 40 can have an offset from neutral bridge plane 42 (horizontal caliper plane) which is representing the height of bridge/plunger (dz_SB_ACT).

In particular, the parking brake actuator 38 and the service brake actuator 40 may be arranged coaxial with an angle of 5° (A_SB_ACT_x and A_PB_ACT_x the bridge inclination is 4° (A_BRIDGE_GUIDE_NEUT) respectively to the rotation direction.

The invention was described by means of an embodiment. The embodiment is only of explanatory nature and does not restrict the invention as defined by the claims. As recognizable by the skilled person, deviations from the embodiment are possible without leaving the invention that is defined according to the scope of the claimed subject-matter.

For example, as a service brake, a pneumatic brake was employed. However, also electromechanical or hydraulic brake systems may be employed there.

For example, the parking brake actuator is configured as a pulling actuator and the service brake actuator is configured as a pushing actuator in the embodiment. However, also mere pushing actuators or pulling actuators or any mix of them may be applied mutatis mutandis.

For example, the caliper 28 is a floating caliper in the embodiment. However, any other kind of caliper is applicable, in particular fixed calipers.

Different embodiments may be combined. In particular the first modification and the second modification may be combined.

A commercial vehicle in the sense of this document is any vehicle, either self-driven or towed, for transporting goods or freight. These are in particular HGV, trucks, tractor units or trailers.

A main brake system or service brake system in the sense of this document is a brake system that is configured to serve for vehicle deceleration during operation, in particular during movement of the vehicle.

An auxiliary brake system/actuator or parking brake system/actuator in the sense of this document is a brake system/actuator that is configured to serve as a backup for the main brake system/actuator and that is configured to provide a continuous locking function to maintain a vehicle's position.

A horizontal caliper plane is a plane that extends tangentially of a brake disc at the location of the brake disc's caliper. Thus, the horizontal caliper plane is horizontal in a case when the caliper is arranged at a 12 o'clock position of the brake disc like in the embodiment. However, if the caliper is arranged at a different position, the horizontal caliper plane is not necessarily horizontal with respect to the usual orientation of the vehicle. In a case when the caliper is arranged at a 9 or 3 o'clock position of the brake disc, the horizontal caliper plane may be even oriented vertically.

In this document, as far as an axis is described as having a specific orientation, e.g. like being parallel to a disc center plane and a horizontal caliper plane, this description encompasses any orientation of that axis within a 15° angle range of deviation in any direction from that worded orientation.

In this document, a wheel axle—as far as a stationary braking element is connected thereto—refers to a non-rotating axle or—e.g. in case of a driven wheel—to a non-rotating part of the axle like an axle casing.

In this document, the terms “and”, “or” and “either . . . or” are used as conjunctions in a meaning similar to the logical conjunctions “AND”, “OR” (often also “and/or”) or “XOR”, respectively. In particular, in contrast to “either . . . or”, the term “or” also includes occurrence of both operands.

Method steps indicated in the description or the claims only serve an enumerative purpose of the method steps. They only imply a given sequence or an order where their sequence or order is explicitly expressed or is—obvious for the skilled person—mandatory due to their nature. In particular, the listing of method steps do not imply that this listing is exhaustive. Also, not all method steps described in an embodiment are required to implement the invention. The required method steps are defined by the claims only.

In the claims, the word “comprising” does not exclude other elements or steps, and the indefinite article “a” or “an” does not exclude a plurality and has to be understood as “at least one”.

### LIST OF REFERENCE SIGNS

1 pivotal axis
2 eccentric lever
3 horizontal caliper plane
4 caliper
5,5′ actuator
6 service brake portion
7 parking brake portion
8,8′ actuator axis
9 brake disc
10 disc center plane
11 bridge
12 bridge guidance
20 braking system
22 brake disc
222 disc center plane
24 outboard brake pad
26 inboard brake pad
28 caliper
30 carrier
32 lever
321 first end portion
322 second end portion
324 support portion
326 pivotal axis
34 adjuster
35 bridge
350 bridge guide plane
36 brake slider
38 parking brake actuator
380 parking brake rod
382 spring arrangement
384 parking brake actuator axis
40 service brake actuator
400 service brake rod
402 pneumatic cylinder
404 service brake actuator axis
42 horizontal caliper plane

1.-10. (canceled)

11. A braking system for a vehicle, comprising:
a rotatory braking element that is fixedly connected to a wheel or wheel hub in a manner to rotate conjointly with the wheel;
a stationary braking element that is directly or indirectly connected to a vehicle chassis such that movement of the stationary braking element is restricted so as to not rotate conjointly with the wheel;
a brake actuator that is configured to actuate the stationary braking element so as to urge the stationary braking element towards the rotatory braking element;
a lever that is configured so as to transfer a force exerted by the brake actuator to the stationary brake element,
wherein a pivot axis of the lever is in parallel with a rotational plane of the rotatory braking element and perpendicular to a horizontal caliper plane that is a plane that is oriented tangentially of the rotatory brake element, and
wherein an actuator axis is in parallel with the rotational plane and the horizontal caliper plane.

12. The braking system according to claim 11, wherein
the brake actuator comprises a main brake actuator and an auxiliary brake actuator, that are arranged at mutually different sides of the lever.

13. The braking system according to claim 12, wherein
a main brake actuator axis and an auxiliary brake actuator axis deviate from a mutual orientation that is parallel to each other.

14. The braking system according to claim 12, wherein
a main brake actuator axis and an auxiliary brake actuator axis are arranged coaxially with an angle of 0° to 5°, 5° to 10° or 10° to 15°, with respect to the rotational plane and/or the horizontal caliper plane.

15. The braking system according to claim 14, wherein
the main brake actuator axis and the auxiliary brake actuator axis are arranged coaxially with an angle of 5° with respect to the rotational plane and/or the horizontal caliper plane

16. The braking system according to claim 11, further comprising:
a transfer element arranged between the lever and the stationary braking element.

17. The braking system according to claim 16, wherein
an orientation of the transfer element is inclined with respect to the rotational plane by 0° to 5°, 5° to 10° or 10° to 15° with respect to the rotation direction.

18. The braking system according to claim 17, wherein
the orientation of the transfer element is inclined with respect to the rotational plane by 4° with respect to the rotation direction.

19. A method of providing a braking system, the method comprising the steps of:
a) providing a rotatory braking element that is fixedly connected to a wheel or wheel hub in a manner to rotate conjointly with the wheel;
b) providing a stationary braking element that is fixedly connected to a vehicle chassis;
c) providing a brake actuator that is configured to actuate the stationary braking element so as to press the stationary braking element towards the rotatory element;
d) providing a lever that is configured so as to transfer a force exerted by the brake actuator to the stationary brake element,
wherein step d) further comprises:
da) orienting a pivot axis of the lever in parallel with a rotational plane of the rotatory braking element and perpendicular to a horizontal caliper plane that is a plane that is oriented tangentially of the rotatory brake element, and
wherein step c) further comprises:
ca) orienting an actuator axis in parallel with the rotational plane and the horizontal caliper plane.

20. The method according to claim 19, wherein step c) further comprises:
cb) providing a main brake actuator;
cc) providing an auxiliary braking actuator; and
cd) arranging the main brake actuator and the auxiliary brake actuator at different sides of the lever.

21. The method according to claim 20, wherein step cd) further comprises:
cda) arranging a main brake actuator axis and an auxiliary brake actuator axis such that they deviate from a mutual orientation that is parallel to each other.

22. The method according to claim 18, further comprising the step of:
e) providing a transfer element between the lever and the stationary braking element.
